(19) United States
(12) Patent Application Publication
(10) Pub. No.: US 2013/0078388 A1
(43) Pub. Date: Mar. 28, 2013

(54) APPARATUS AND METHOD FOR CHARGING NANOPARTICLES

(71) Applicants: Markku Rajala, Vantaa (FI); Kauko Janka, Tampere (FI); Sami Kauppinen, Vantaa (FI)

(72) Inventors: Markku Rajala, Vantaa (FI); Kauko Janka, Tampere (FI); Sami Kauppinen, Vantaa (FI)

(73) Assignee: BENEQ OY, Vantaa (FI)

(21) Appl. No.: 13/701,734

(22) PCT Filed: Jun. 29, 2010
(86) PCT No.: PCT/FI2010/050556

§ 371 Date: Dec. 3, 2012

(51) Int. Cl. B01J 19/06; B01J 8/00

(52) U.S. Cl. CPC B01J 19/06; B01J 8/005
USPC 427/483; 425/6; 118/623; 264/10

(57) ABSTRACT

An apparatus and method for electrically charging nanoparticles. The invention including atomizing one or more liquid starting materials into droplets, electrically charging the droplets during or after the atomization and vaporizing the one or more liquid materials of the droplets for generating the nanoparticles from the liquid droplets such that the electrical charge of the droplets is transferred into the nanoparticles for producing electrically charged nanoparticles.

### FIELD OF THE INVENTION

The present invention relates to an apparatus for charging nanoparticles and particularly to an apparatus according to the preamble of claim 1. The present invention further relates to a method for charging nanoparticles and particularly to a method according to the preamble of claim 12.

### BACKGROUND OF THE INVENTION

Nanoparticles, i.e. particles having a size of 1 to 1000 nanometres, have been found to have a plurality of significant applications in industry, for example in glass industry for producing catalytic surfaces, self-cleaning and antibacterial products, glass dyeing and manufacturing of optical components, such as an optical fibre, etc. Feasible production of nanoparticles is a crucial factor in view of the feasible use of these applications. Relatively narrow size distribution (monodispersivity), anti-agglomeration and homogeneity are required of the nanoparticles. Nanoparticle production should be readily convertible from laboratory-scale production to industrial-scale production. In industrial scale nanoparticles are usually produced by vapour phase processes. The vapour phase processes, also known as aerosol reactor processes, include flame reactors, hot-wall reactors, plasma reactors, gas condensation methods, laser ablation and spray pyrolysis among other things.

The problem of the prior art is that nanoparticles used in industry are difficult to control when they are used in industrial application. Nanoparticles are for example deposited on substrates for providing a coating on a substrate or adjusting the surface properties of a substrate. Due to the small size of the nanoparticles they are difficult to deposit uniformly. Thus a non-uniform flux of nanoparticles is produced. The non-uniform flux is due to the fact it is difficult to control and guide the produced nanoparticles. Furthermore the prior art has the disadvantage that the material efficiency is rather low and the deposition is difficult to control and adjust as necessary. One solution to the mentioned problems is to electrically charge the nanoparticles and to use electrical forces to control or deposit the charged nanoparticles.

However, electrically charging nanoparticles is very difficult and it cannot be carried out in industrial scale using the known prior art techniques. The small size of the nanoparticles makes the electrically charging of the nanoparticles ineffective.

### BRIEF DESCRIPTION OF THE INVENTION

An object of the present invention is to provide an apparatus for electrically charging nanoparticles and a method for electrically charging nanoparticles so as to overcome the above mentioned problems. The objects of the invention are achieved by an apparatus for electrically charging nanoparticles according to the characterizing portion of claim 1. The objects of the present invention are further achieved with a method for electrically charging nanoparticles according to the characterizing portion of claim 12. The preferred embodiments of the invention are disclosed in the dependent claims.

The invention is based on the idea of electrically charging the nanoparticles in an indirect way. According to the present invention first one or more liquid starting materials are vaporized into droplets using one ore more atomizers. The produced droplets are further electrically charged during or after the atomization and the electrically charged droplets are conducted to an evaporation chamber in which nanoparticles are produced from the liquid droplets by vaporizing the liquid materials from the droplets. The nanoperticles may further be deposited on a substrate. According to the present invention the liquid droplets are electrically charged during or after the atomization before they are conducted to an evaporation chamber and before the liquid materials of the droplets are vaporized. When the liquid materials of the droplets vaporize the electrical charge of the droplets is transferred to the nanoparticles present in the droplets or formed during vaporization of the liquid materials of the droplets. Thus when the electrical charge of the droplets is transferred into the nanoparticles electrically charged nanoparticles are produced. The electrically charged nanoparticles may be guided or deposited on a substrate using one or more electric fields.

An advantage of the present invention is that electrically charging the droplets enables the produced nanoparticles also to be electrically charged as the electrical charge of the liquid droplets is transferred to the nanoparticles when the liquid materials of the nanoparticles is vaporized. Electrically charging the nanoparticles using the indirect way according to the present invention provides an efficient and industrially applicable solution for electrically charging nanoparticles. Furthermore, the electrical charge of the nanoparticles makes the flux of nanoparticles more uniform due to the repulsive electrical forces of the charged nanoparticles. In other words the charged nanoparticles repel each other due to the electrical charge such that the flux or distribution of the nanoparticles becomes more uniform. The electric charge of the nanoparticles also enables controlling or guiding the nanoparticles efficiently by using one or more electric fields. Thus the electrically charged nanoparticles may be controlled and guided using electric fields such that the charged nanoparticles may be efficiently deposited on a substrate.

### BRIEF DESCRIPTION OF THE DRAWINGS

In the following the invention will be described in greater detail by means of preferred embodiments with reference to the attached [accompanying] drawings, in which

FIG. 1A shows schematically a device for producing nanoparticles;

FIG. 1B shows schematically one embodiment of the present invention for producing electrically charged nanoparticles and depositing the electrically charged nanoparticles on a substrate; and

FIGS. 1C and 1D show alternative methods for producing electrically charged nanoparticles.

### DETAILED DESCRIPTION OF THE INVENTION

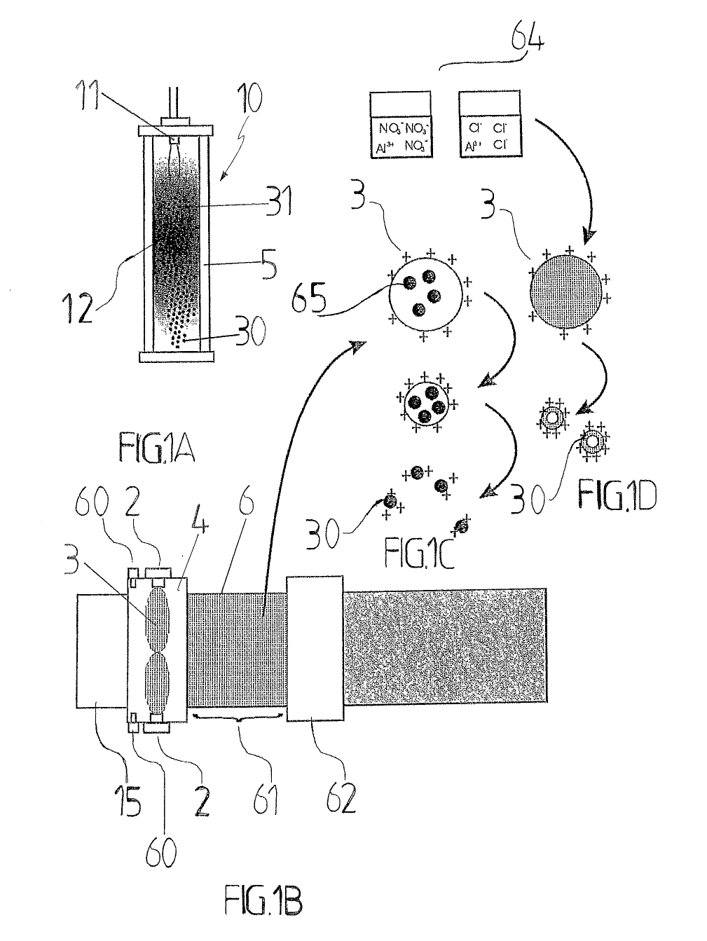

FIG. 1A shows a device 10 for producing nanoparticles 30. The device 10 comprises an atomizer 11 for atomizing a one or more liquid raw materials into droplets 31 in chamber 5. The liquid raw materials are atomized preferably using a two-fluid atomizer 11 in which atomization gas or gases is fed to the two-fluid atomizer 11 for atomizing the liquid raw material into droplets 31. The formed droplets 31 are further conducted to a flame 12 generated with the aid of fuel gases and oxidizing gases. The flame 12 is preferably provided with the two-fluid atomizer 11 by supplying the fuel gases and the oxidizing gases from the atomizer 11, whereby droplets 31 are formed in the same device with the flame 12. The fuel gases and/or oxidizing gases may also be used as atomization gas for forming the droplets 31 or they me be supplied separate from the atomization gases. The droplets 31 are passed into the flame 12 in the liquid form and in the flame 12 the liquid raw materials are converted to nanoparticles 30 whose composition may be different from that of the liquid raw materials. The nanoparticles 30 are formed through nucleation in a known manner. The above mentioned way of producing nanoparticles 30 is prior art. Thus it should be noted that nanoparticles 30 may also be produced in some other known manner.

The device 10 for producing nanoparticles 30 produces preferably nanoparticles 30 and water vapour. The nanoparticles 30 and the water vapour and are further condensed into a liquid starting material comprising the nanopartilces 30. Formed nanoparticles 30 may also be mixed into a liquid material in some other way for providing a liquid starting material having nanoparticles. However it should be noted that the liquid starting material comprising nanoparticles 30 may be provided in any other know method. This kind of liquid starting material comprising nanoparticles 30 may be any colloidal solution or dispersion comprising one or more liquid materials and solid nanoparticles 30.

FIG. 1B shown an apparatus for charging nanoparticles 30, or producing electrically charged nanoparticles 30 and depositing the electrically charged nanoparticles on a substrate 15. The one or more liquid starting materials comprising the nanoparticles 30 are first atomized into droplets 3 in a two-fluid atomizer 2. Also other kind of atomizers may be used. Preferably the liquid starting materials are atomized into droplets 3 having diameter 10 μm or less, more preferably 3 μm or less. The formed droplets 3 are electrically charged during or after the atomization. FIG. 1B shows a solution in which the formed droplets 3 are electrically charged in an atomization chamber 4 by using blow chargers 60 supplying electrically charged gas in to the atomization chamber. The electrical charged gas charges the droplets 3. The droplets 3 may also be charged in any other way known manner. For example the atomizer 2 may be a two-fluid atomizer, and it may comprise charging means (not shown), such as corona electrodes, arranged to charge at least a fraction of the gas used in the two-fluid atomizer 2 for electrically charging the droplets 3. Alternatively the charging means comprises one or more corona electrodes for electrically charging the droplets 3 after the atomization. The corona electrodes may be provided to the atomization chamber 4.

The electrically charged droplets 3 are further conducted to an evaporation chamber 6 for generating electrically charged nanoparticles 30. The evaporation chamber 6 is arranged to vaporize the one or more liquid materials from the electrically charged droplets 3 for producing electrically charged nanoparticles 30 from the solid nanoparticles 30 in the droplets 3. During the vaporization of the liquid materials of the electrically charged droplets 3 the electrical charge of the droplets 3 is transferred into the nanoparticles 30 present in the droplets 3 and electrically charged nanoparticles 30 are formed. The nanoparticles 30 do not comprise any liquid material or the amount or mass of liquid material in the nanoparticles 30 is small compared to the mass of the solid material in the nanoparticles 30.

The evaporation chamber 6 may comprise one or more hot zones for enhancing the vaporization of the one or more liquid materials of the droplets 3. The hot zone may be provided by means of gas or with heating means, such as, heat radiator, electric resistor or some other means for providing the hot zone. The elevated temperature of the hot zone enhances and accelerates the evaporation of the liquid material from the droplets 3.

The liquid droplets 3 may form nanoparticles 30 at least in two alternative ways as shown in FIGS. 1C and 1D. FIG. 1C shows the principle of the above disclosed method for producing electrically charged nanoparticles 30 from a liquid starting material 64 comprising solid nanoparticles 65. The solid nanoparticles 65 preferably have average diameter about 100 nm or less. This kind of starting material 64 having the solid nanoparticles 65 may be a colloidal solution or dispersion. The liquid starting material 64 having the solid particles 65 is first atomized by an atomizer 2 into droplets 3. The solid particles 65 are then in the droplets 3. The droplets 3 are further electrically charged and conducted to an evaporation chamber 6 in which the liquid material of the droplets 3 is vaporized and the electrical charge of the droplets 3 is transferred to the formed nanoparticles 30. The liquid starting material may comprise one or more type of colloidal nanoparticles such that one or more type of electrically charged nanoparticles 30 is produced.

An alternative way of producing electrically charged nanoparticles 30 is shown in FIG. 1D. The liquid starting material 64 may comprise one or more solvents and one or more solid substances dissolved into the solvent. The solid substance may comprise salt or salts or the like. The liquid starting material 64 having comprising the solvent and the dissolved solid substance is atomized into droplets in the same way described above, and the droplets 3 are further electrically charged as describe above. The electrically charged droplets 3 are further conducted to an evaporation chamber 6 in which the solvent is vaporized and the dissolved solid material forms nanoparticles 30 as the droplets 3 dry or as the solvent of the liquid starting material 64 vaporizes. The nanoparticles 30 formed as in FIG. 1D are usually hollow nanoparticles 30.

According to the above mentioned the electrically charged nanoparticles 30 are produced by atomizing one or more liquid starting materials 64 into droplets 3, electrically charging the droplets 3 during or after the atomization and vaporizing the one or more liquid materials of the droplets 3 for generating the nanoparticles 30 from the liquid droplets 3 such that the electrical charge of the droplets 3 is transferred into the nanoparticles 30 for producing electrically charged nanoparticles 30. FIG. 1 B shows one embodiment for depositing nanoparticles 30 on a substrate 15. The machine of FIG. 1B comprises atomizers 2 for producing droplets 3 from one or more liquid starting materials. The produced droplets 3 are electrically charged using one or more blow chargers 60 supplying electrically charged gas which in turn electrically charges the droplets 3. The droplets 3 may also be charged in any other way described above. For example the atomizer 2 may be a two-fluid atomizer, and that the charging means are arranged to charge at least a fraction of the gas used in the two-fluid atomizer 2 for electrically charging the droplets 3. Alternatively the charging means comprises one or more corona electrodes for electrically charging the droplets 3 after the atomization. The blow charger 60 or the corona electrodes may be provided to the atomization chamber 4 or to the deposition chamber 6 or to a separate charging chamber upstream of the deposition chamber 6 or in another location upstream of the deposition chamber 6.

The electrically charged droplets 3 are further conducted to an evaporation chamber 6, which in this embodiment also serves as a deposition chamber, for generating electrically charged nanoparticles 30. The liquid droplets 3 may form nanoparticles 30 at least in two alternative ways as described above in connection with FIGS. 1C and 1D.

From the atomization chamber 4 the charged droplets 3 are conducted to a deposition chamber 6. The deposition chamber 6 is provided with an electric field 61 for guiding the electrically charged droplets 3 towards the glass substrate 15 and/or depositing the electrically charged nanoparticles 30 on the substrate 15, as shown in FIG. 1B. The deposition chamber 6 may also comprise two or more electric fields 61 arranged adjacently and/or successively in the movement direction of the nanoparticles 30. At least some of the adjacent and/or successive electric fields 61 may have same or different electric field strength for adjusting distribution of the electrically charged nanoparticles 30 or droplets. The deposition chamber may be provided with one or more hot zones (not shown) for enhancing and accelerating the evaporation and drying of the liquid materials of the droplets 3, as disclosed above. Also the substrate 15 may be at an elevated temperature such that the substrate itself forms a hot zone close to the surface of the substrate 15 by providing thermal energy for enhancing the vaporization or drying of the droplets 3.

The glass substrate 15 having the nanoparticles 30 deposited on it is then conducted to a heat treatment 62 which may be carried out using gas blowers, burners, heat radiators, oven, laser or the like.

It will be obvious to a person skilled in the art that, as the technology advances, the inventive concept can be implemented in various ways. The invention and its embodiments are not limited to the examples described above but may vary within the scope of the claims.

1. An apparatus for electrically charging nanoparticles (30), characterized in that the apparatus comprises:
at least one atomizer (2) for atomizing one or more liquid starting materials into droplets (3);
charging device (60) for electrically charging the droplets (3) during or after the atomization; and
an evaporation chamber (6) arranged to vaporize the one or more liquid starting materials of the droplets (3) for generating the nanoparticles (30) from the liquid droplets (3) such that the electrical charge of the droplets (3) is transferred into the nanoparticles (30) for producing electrically charged nanoparticles (30).

2. An apparatus according to claim 1, characterized in that the atomizer (2) is a two-fluid atomizer, and that the charging device is arranged to charge at least a fraction of the gas used in the two-fluid atomizer (2) for electrically charging the droplets (3).

3. An apparatus according to claim 2, characterized in that the charging device comprises one or more corona electrodes for electrically charging the at least a fraction of the gas used in the two-fluid atomizer (2) for electrically charging the droplets (3).

4. An apparatus according to claim 1, characterized in that the charging device comprises one or more corona electrodes for electrically charging the droplets (3), or that charging means comprises one or more blow chargers supplying electrically charged gas for charging the droplets (3).

5. An apparatus according any one of claims 1 to 4, characterized in that the one or more liquid starting materials comprises a colloidal solution or dispersion comprising one or more liquid materials and solid nanoparticles (30).

6. An apparatus according any one of claims 1 to 4, characterized in that one or more liquid starting materials comprises one or more solvents and one or more solid substances dissolved into the solvent.

7. An apparatus according to claim 6, characterized in that the solid substance is a salt or salts.

8. An apparatus according to claim 5, characterized in that the evaporation chamber (6) is arranged to vaporize the one or more liquid materials from the electrically charged droplets (3) for forming electrically charged nanoparticles (30).

9. An apparatus according to claim 6 or 7, characterized in that the evaporation chamber (6) is arranged to vaporize the one or more solvents from the electrically charged droplets (3) for producing electrically charged nanoparticles (30) from the solid substances or salts dissolved into the one or more solvents.

10. An apparatus according any one of claims 1 to 9, characterized in that the evaporation chamber (6) comprises one or more hot zones for enhancing the vaporization of the one or more liquid materials of the droplets (3).

11. An apparatus according any one of claims 1 to 10, characterized in that the apparatus is used in a deposition machine having one or more electrical fields for depositing the charged nanoparticles (30) on a substrate (15).

12. A method for electrically charging nanoparticles (30), characterized in that the method comprises:
atomizing one or more liquid starting materials into droplets (3);
electrically charging the droplets (3) during or after the atomization; and
vaporizing the one or more liquid materials of the droplets (3) for generating the nanoparticles (30) from the liquid droplets (3) such that the electrical charge of the droplets (3) is transferred into the nanoparticles (30) for producing electrically charged nanoparticles (30).

13. A method according to claim 12, characterized by atomizing the one or more liquid starting materials by a two-fluid atomizer (2) and charging at least a fraction of the gas used in the two-fluid atomizer (2) for electrically charging the droplets (3).

14. A method according to claim 12, characterized by charging the droplets (3) after the atomization by one or more corona electrodes or by one or more blow chargers supplying electrically charged gas for charging the droplets (3).

15. A method according any one of claims 12 to 14, characterized in that the one or more liquid starting materials comprises a colloidal solution or dispersion comprising one or more liquid materials and solid nanoparticles (30).

16. A method according any one of claims 12 to 14, characterized in that one or more liquid starting materials comprises one or more solvents and one or more solid substances dissolved into the solvent.

17. A method according to claim 16, characterized in that the solid substance is a salt or salts.

18. A method according to claim 15, characterized by vaporizing the one or more liquid materials from the electrically charged droplets droplets (3) for forming electrically charged nanoparticles (30).

19. A method according to claim 16 or 17, characterized by vaporizing the one or more solvents from the electrically charged droplets (3) for producing electrically charged nanoparticles (30) from the solid substances or salts dissolved into the one or more solvents.

20. A method according any one of claims 12 to 19, characterized by heating droplets (3) for enhancing the vaporization of the one or more liquid materials of the droplets (3).

21. A method according any one of claims 12 to 20, characterized by using the method for depositing nanoparticles (30) on a substrate (15) with one or more electrical fields.
